(19) United States
(12) Patent Application Publication
(10) Pub. No.: US 2024/0408673 A1
(43) Pub. Date: Dec. 12, 2024

(54) Laminate Molding Apparatus and Laminate Molding Method

(71) Applicants: OSAKA UNIVERSITY, Suita-shi (JP); SHIMADZU CORPORATION, Kyoto-shi (JP)

(72) Inventors: Norio YOSHIDA, Suita-shi (JP); Yuji SATO, Suita-shi (JP); Masahiro TSUKAMOTO, Suita-shi (JP); Masahiro IHAMA, Suita-shi (JP); Koji TOJO, Kyoto-shi (JP); Shingo UNO, Kyoto-shi (JP)

(21) Appl. No.: 18/733,050

(22) Filed: Jun. 4, 2024

(30) Foreign Application Priority Data
Jun. 6, 2023 (JP) 2023-092984

(51) Int. Cl. B22F 10/322; B22F 10/28; B22F 12/70; B33Y 10/00; B33Y 30/00; B33Y 50/02

(52) U.S. Cl. CPC B22F 10/322; B22F 10/28; B22F 12/70; B33Y 10/00; B33Y 30/00; B33Y 50/02; B22F 2201/10; B22F 2301/35

(57) ABSTRACT

An additive manufacturing apparatus includes: a chamber; a gas supply device that supplies an ambient gas into the chamber; an irradiation device that irradiates a molding region with an energy beam in order to mold a three dimensional molding object, the molding region being provided with a powder bed fusion on which a powder is spread in the chamber; and a controller that performs control related to additive manufacturing of the molding object, wherein the controller is configured to increase a pressure of the ambient gas in the chamber to be higher than an atmospheric pressure when the molding object is molded.

### CROSS REFERENCE TO RELATED APPLICATIONS

This nonprovisional application is based on Japanese Patent Application No. 2023-092984 filed on Jun. 6, 2023 with the Japan Patent Office, the entire contents of which are hereby incorporated by reference.

### BACKGROUND OF THE INVENTION

### Field of the Invention

The present invention relates to an additive manufacturing apparatus and an additive manufacturing method.

### Description of the Background Art

As conventional additive manufacturing apparatuses, additive manufacturing apparatuses that perform three dimensional additive manufacturing using various additive manufacturing methods such as powder bed fusion method are known. In order to suppress the deterioration of the quality of the molding object, some of these additive manufacturing apparatuses control the inert gas used in the additive manufacturing apparatuses.

As a first example of controlling the inert gas to suppress the deterioration of the quality of the molding object, there is an additive manufacturing apparatus including a configuration of reducing an oxygen concentration in a molding chamber in a short time (Japanese Patent Laying-Open No. 2016-74957). As a second example of controlling the inert gas to suppress the deterioration of the quality of the molding object, there is an additive manufacturing apparatus including a configuration in which oxygen is effectively discharged so that the oxygen which oxidizes the molding object does not remain in the molding apparatus (Japanese Patent Laying-Open No. 2017-109355).

### SUMMARY OF THE INVENTION

However, in a conventional additive manufacturing apparatus that performs additive manufacturing using a powder bed fusion method, when a molding object is molded by irradiating a powder bed fusion with an energy beam such as a laser beam, metal vapor called plume may be explosively generated and diffused. There is a problem that when such metal vapor diffuses excessively, metal powder and melted metal contained in the powder bed fusion scatter, and thereby defects occur in the molding object due to formation of spatter or formation of voids.

The present invention has been made to solve the above problem, and an object of the present invention is to suppress the occurrence of defects in a molding object when additive manufacturing is performed.

An additive manufacturing apparatus according to an aspect of the present invention includes: a chamber; a gas supply device that supplies an ambient gas into the chamber; an irradiation device that irradiates a molding region with an energy beam in order to mold a three dimensional molding object, the molding region being provided with a powder bed fusion on which a powder is spread in the chamber; and a controller that performs control related to additive manufacturing of the molding object. The controller is configured to increase a pressure of the ambient gas in the chamber to be higher than an atmospheric pressure when the three dimensional molding object is molded.

An additive manufacturing method according to another aspect of the present invention includes: supplying an ambient gas from a gas supply device into a chamber; irradiating a molding region with an energy beam from an irradiation device in order to mold a three dimensional molding object, the molding region being provided with a powder bed fusion on which a powder is spread in the chamber; and increasing a pressure of the ambient gas in the chamber to be higher than an atmospheric pressure when the molding object is molded.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of an additive manufacturing apparatus 1 of a first embodiment.

FIG. 2 is a block diagram showing a control configuration of additive manufacturing apparatus 1.

FIG. 3 is a diagram showing a relation among pressure of an ambient gas, plume, and powder scattering.

FIG. 4 is a graph showing a relation between pressure of the ambient gas and a melting cross-sectional area of an iron-based material.

FIG. 5 is a flowchart showing a method of controlling pressure of the ambient gas of additive manufacturing apparatus 1.

FIG. 6 is a sectional view of additive manufacturing apparatus 1 showing a configuration of a volume adjusting device 90 of additive manufacturing apparatus 1 according to a third embodiment.

### DESCRIPTION OF THE PREFERRED EMBODIMENTS

Hereinafter, embodiments of the present invention will be described in detail with reference to the drawings. In the following description, the same or corresponding parts in the drawings are denoted by the same reference signs, and the description thereof will not be repeated in principle. Although a plurality of embodiments will be described below, it is planned from the beginning of the application that the configurations described in the embodiments are appropriately combined.

### First Embodiment

In the first embodiment, a technique will be described in which, in a case where a three dimensional molding object is manufactured using an additive manufacturing method called powder bed fusion method, occurrence of defects in the three dimensional molding object is suppressed by performing control to increase pressure of an ambient gas to be higher than the atmospheric pressure.

### [Overall Configuration of Additive Manufacturing Apparatus 1]

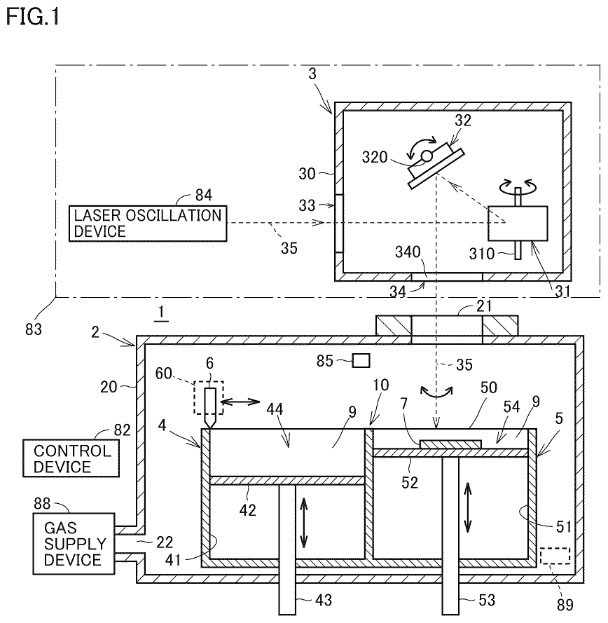

FIG. 1 is a cross-sectional view showing a configuration of an additive manufacturing apparatus 1 of a first embodiment. Additive manufacturing apparatus 1 includes a chamber 2, an irradiation device 83, a gas supply device 88, and a controller 82. Irradiation device 83 includes a laser oscillation device 84 and a galvanometer mirror device 3.

Chamber 2 is a container constituted of a first housing 20 which is made of a metal and has airtightness. Gas supply device 88 supplies an ambient gas such as an inert gas to an internal space of chamber 2. The gas used as the ambient gas is, for example, nitrogen gas. As the ambient gas, other inert gases such as helium gas, argon gas, neon gas, or the like may be used. Laser oscillation device 84 oscillates a laser beam 35 as an energy beam.

Irradiation device 83 includes laser oscillation device 84 and galvanometer mirror device 3. Laser oscillation device 84 oscillates laser beam 35. Galvanometer mirror device 3 is an optical device that reflects laser beam 35 oscillated from laser oscillation device 84 and causes reflected laser beam 35 to enter chamber 2.

Galvanometer mirror device 3 includes a first mirror 31 and a second mirror 32 as optical devices that reflect laser beam 35. In galvanometer mirror device 3, first mirror 31 and second mirror 32 are provided inside a second housing 30.

First mirror 31 is rotatable as indicated by arrows in the drawing about a first rotation shaft 310, the axis of which is provided in the vertical direction, as a rotation axis. Second mirror 32 is rotatable as indicated by arrows in the drawing about a second rotation shaft 320, the axis of which is provided in the horizontal direction, as a rotation axis.

Second housing 30 of galvanometer mirror device 3 is provided with a transparent incident window 33 through which laser beam 35 can enter, and a transparent emission window 34 through which laser beam 35 can be emitted. Emission window 34 is provided with a scanning Fθ lens 340 for condensing laser beam 35. Laser beam 35 oscillated from laser oscillation device 84 is made incident on the inside of second housing 30 of galvanometer mirror device 3 from incident window 33.

On the inside of second housing 30, laser beam 35 incident from incident window 33 is reflected by first mirror 31 and is incident on second mirror 32. Laser beam 35 incident on second mirror 32 is reflected by second mirror 32, condensed by scanning Fθ lens 340, and emitted from emission window 34 toward chamber 2.

A molding unit 10 is provided inside first housing 20 of chamber 2. Molding unit 10 includes a powder supply device 4, a processing stage device 5, and a recoater device 60.

In first housing 20 of chamber 2, a transparent incident window 21 through which laser beam 35 emitted from emission window 34 of galvanometer mirror device 3 enters is provided in a part facing emission window 34 of galvanometer mirror device 3.

A tubular gas supply path 22 for supplying the ambient gas generated by gas supply device 88 into chamber 2 is provided in a portion of first housing 20 of chamber 2.

Powder supply device 4 includes a first guide chamber 41, a first stage 42, and a first movable prop 43. First stage 42 is mounted on first movable prop 43. First stage 42 and a portion of first movable prop 43 are provided inside first guide chamber 41. In the internal space of first guide chamber 41, first movable prop 43 and first stage 42 are provided in a manner that first stage 42 can be elevated and lowered along an inner wall of first guide chamber 41.

On the upper surface side of first stage 42, for example, powder 9 made of iron-based metal powder is placed. Thus, powder 9 is accommodated in a space formed by the upper surface of first stage 42 and the inner wall of first guide chamber 41. In powder supply device 4, a space in which powder 9 is accommodated is referred to as powder accommodation region 44.

First movable prop 43 can move up and down in the axial direction as indicated by arrows in the drawing. Thus, first stage 42 can be elevated and lowered in accordance with the up-down movement of first movable prop 43. A ring-shaped airtight holding member (not shown) is provided on the outer peripheral portion of first stage 42, and thus the outer peripheral portion of first stage 42 and the inner wall of first guide chamber 41 are airtightly held.

Processing stage device 5 includes a second guide chamber 51, a second stage 52, and a second movable prop 53. Second stage 52 is mounted on second movable prop 53. Second stage 52 and a portion of second movable prop 53 are provided inside second guide chamber 51. In the internal space of second guide chamber 51, second movable prop 53 and second stage 52 are provided in a manner that second stage 52 can be elevated and lowered along an inner wall of second guide chamber 51.

Second movable prop 53 can move up and down in the axial direction as indicated by arrows in the drawing. Thus, second stage 52 can be elevated and lowered in accordance with the up-down movement of second movable prop 53. A ring-shaped airtight holding member (not shown) is provided on the outer peripheral portion of second stage 52, and thus the outer peripheral portion of second stage 52 and the inner wall of second guide chamber 51 are airtightly held.

Powder 9 supplied from powder supply device 4 can be accommodated in a space formed by the upper surface of second stage 52 and the inner wall of second guide chamber 51. Powder 9 is supplied from powder supply device 4 to processing stage device 5 by being conveyed in accordance with the operation of a recoater 6.

Recoater 6 is a blade-shaped member and is provided above powder supply device 4, which supplies powder 9, and processing stage device 5. Recoater 6 is a member capable of pushing powder 9 on powder supply device 4 onto processing stage device 5 by reciprocating in the horizontal direction above powder supply device 4 and processing stage device 5 as indicated by arrows in the drawing. Recoater 6 is included in recoater device 60 including a recoater driving device for operating recoater 6.

Recoater 6 has a function of uniformly spreading powder 9 all over second stage 52 of processing stage device 5 by moving in the horizontal direction in a mode of pushing powder 9 in the horizontal direction. In this way, the aggregate of powder 9 spread all over second stage 52 constitutes a powder bed fusion 50.

Laser beam 35 emitted from emission window 34 of galvanometer mirror device 3 is transmitted through incident window 21 of chamber 2 and is incident on a region on second stage 52. Therefore, powder bed fusion 50 in the region on second stage 52 is irradiated with laser beam 35 that has entered through incident window 21 of chamber 2. Due to the energy of laser beam 35 thus emitted, in powder bed fusion 50, powder 9 is melted by the thermal energy of incident laser beam 35, and then the melted metal is solidified, thereby molding a molding object 7.

In this way, powder 9 and molding object 7 molded by laser beam 35 using powder 9 as a raw material are accommodated in the space formed by the upper surface of second stage 52 and the inner wall of second guide chamber 51. Thus, the region in which powder 9 is accommodated is a region in which molding object 7 is molded by irradiating powder bed fusion 50 with laser beam 35, and is referred to as molding region 54.

In molding region 54, three dimensional molding object 7 is molded by forming and laminating molding object 7 in a large number of layers in a mode of laminating in the upward direction.

A pressure detection device 85 for detecting the pressure in the internal space of chamber 2 is provided inside chamber 2. The pressure and the like of the ambient gas in chamber 2 are detected by pressure detection device 85.

Controller 82 controls various devices of additive manufacturing apparatus 1 including laser oscillation device 84, galvanometer mirror device 3, powder supply device 4, processing stage device 5, recoater 6, and gas supply device 88.

### [Control Configuration of Additive Manufacturing Apparatus 1]

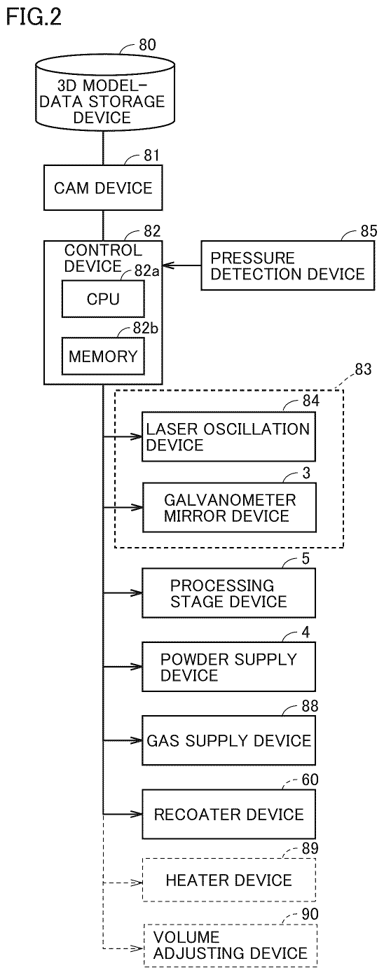

FIG. 2 is a block diagram showing a control configuration of additive manufacturing apparatus 1. A control configuration of additive manufacturing apparatus 1 will be described with reference to FIG. 2.

Additive manufacturing apparatus 1 includes a 3D model-data storage device 80, a computer-aided manufacturing (CAM) device 81, and controller 82 in addition to the configuration described with reference to FIG. 1. 3D model-data storage device 80 stores data of a three dimensional model related to molding object 7. CAM device 81 generates a data used for computer-aided manufacturing and sends the data to controller 82 based on the data of the three dimensional model stored in 3D model-data storage device 80.

Controller 82 is constituted of a computer including a central processing unit (CPU) 82a, a memory 82b (various storage devices including a read only memory (ROM), a random access memory (RAM), a nonvolatile memory such as a flash memory, and the like), an input/output buffer (not shown) for inputting and outputting various signals, and the like.

An input device (not shown) for inputting various data is connected to controller 82. The input device includes various input devices such as a keyboard and a mouse. A display device (not shown) that displays various images is connected to controller 82.

The ROM stores various software programs indicating processing procedures related to control executed by controller 82. CPU 82a expands the software programs stored in the ROM into the RAM or the like and executes the software programs.

Galvanometer mirror device 3 shown in FIG. 2 includes a driving device for driving first mirror 31 and a driving device for driving second mirror 32. Powder supply device 4 shown in FIG. 2 includes a drive device for driving first movable prop 43. Processing stage device 5 shown in FIG. 2 includes a driving device for driving second movable prop 53. Recoater device 60 shown in FIG. 2 includes a driving device for driving recoater 6.

Controller 82 operates in accordance with the software programs, and supplies control signals to various devices such as laser oscillation device 84, galvanometer mirror device 3, powder supply device 4, processing stage device 5, recoater device 60, and gas supply device 88 to control the various devices. Further, a detection signal of the pressure of the ambient gas in chamber 2 is input from pressure detection device 85 to controller 82.

### [Basic Operation of Additive Manufacturing Apparatus 1]

Additive manufacturing apparatus 1 is controlled to basically perform the following operation when molding object 7 is molded. The operation described below is controlled by controller 82.

In powder supply device 4, first stage 42 is operated to move up one step in accordance with the upward movement of first movable prop 43 by one step. Thus, powder 9 accommodated in powder accommodation region 44 is raised by one step in the upper portion of powder supply device 4. Recoater 6 is operated to push powder 9 which is raised in the upper portion of powder supply device 4 in the horizontal direction and move powder 9 to the upper portion of processing stage device 5 in the horizontal direction. Thus, powder 9 is supplied to processing stage device 5 in a mode that powder 9 in the upper portion of powder supply device 4 is carried to the upper portion of processing stage device 5 by the operation of recoater 6.

In this way, recoater 6 is operated to carry powder 9 on first stage 42 of powder supply device 4 onto second stage 52 of processing stage device 5 and to uniformly spread powder 9 all over second stage 52.

Recoater 6 can uniformly spread powder 9 all over second stage 52 of processing stage device 5 by moving in the horizontal direction in a mode of pushing powder 9 in the horizontal direction. In this way, the aggregate of powder 9 spread all over second stage 52 constitutes powder bed fusion 50.

Laser beam 35 emitted from emission window 34 of galvanometer mirror device 3 is transmitted through incident window 21 of chamber 2 and is irradiated to powder bed fusion 50. In powder bed fusion 50, powder 9 is melted by the thermal energy of incident laser beam 35, and then the melted metal is solidified, thereby molding object 7 is molded.

In galvanometer mirror device 3, the radiation direction of laser beam 35 is changed by the rotation of first mirror 31. The irradiation position of laser beam 35 on the upper surface of powder bed fusion 50 is changed in, for example, an x-axis direction by the rotation of first mirror 31. Therefore, the irradiation position of laser beam 35 is scanned in the x-axis direction on the upper surface of powder bed fusion 50 by the rotation of first mirror 31.

In galvanometer mirror device 3, for example, the radiation direction of laser beam 35 is changed by the rotation of second mirror 32. The incident position of laser beam 35 on the upper surface of powder bed fusion 50 is changed in, for example, a y-axis direction by the rotation of second mirror 32. The y-axis direction is orthogonal to the x-axis direction described above. Therefore, the irradiation position of laser beam 35 is scanned in the y-axis direction on the upper surface of powder bed fusion 50 by the rotation of second mirror 32.

In additive manufacturing apparatus 1, the galvanometer mirror device 3 controls the movement of first mirror 31 and second mirror 32 to control the scanning of laser beam 35 to be emitted on the upper surface of powder bed fusion 50, thereby molding one layer of molding object 7 in a shape corresponding to the scanning position of laser beam 35.

In additive manufacturing apparatus 1, three dimensional molding object 7 is molded by laminating molding object 7. Therefore, when the first scanning control of laser beam 35 on the upper surface of powder bed fusion 50 is finished, second stage 52 is moved downward by one step in accordance with the downward movement of second movable prop 53 by one step in processing stage device 5. Thus, in molding region 54 of the upper portion of processing stage device 5, the positions of powder 9 and the upper surface of molding object 7 are lowered by one step, and a space for newly putting powder 9 is generated in molding region 54 in the upper portion of processing stage device 5.

Then, in order to mold the next layer of molding object 7, the above-described operation of supplying powder 9 to processing stage device 5 by powder supply device 4 and recoater 6 is repeatedly performed, thereby powder bed fusion 50 spread all over with new powder 9 is formed above the layer in which molding object 7 is molded in the upper portion of processing stage device 5.

In powder bed fusion 50 all over which new powder 9 is thus spread, laser beam 35 for molding the next layer of molding object 7 is emitted from galvanometer mirror device 3, and the laser beam is newly incident on powder bed fusion 50 to scan powder bed fusion 50. Thereby, the next layer of molding object 7 is molded. By repeating such operations of powder supply device 4, recoater 6, processing stage device 5, and galvanometer mirror device 3, three dimensional molding object 7 is molded on second stage 52.

Thus, in additive manufacturing apparatus 1, when additive manufacturing of molding object 7 is performed, controller 82 performs control to increase the pressure of the ambient gas supplied to the internal space of chamber 2 to a pressure higher than the atmospheric pressure.

### [Relation Among Pressure of Ambient Gas, Plume, and Powder Scattering]

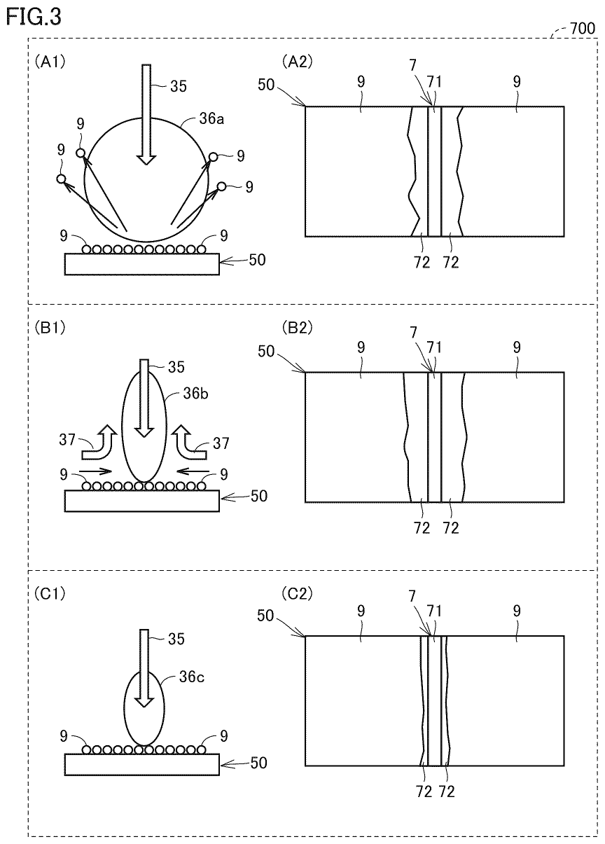

FIG. 3 is a diagram showing a relation among the pressure of the ambient gas, plume, and powder scattering. In FIG. 3, the relation between plume and powder scattering is shown in three types in a frame 700 of a table. The plume is a metal vapor generated by evaporation of metal powder that is rapidly heated when the powder bed fusion is irradiated with a laser beam. The plume generates a vapor flow and a gas flow, and therefore may cause the molten metal to scatter and generate spatter, or may cause the powder present around the irradiation position of the laser to scatter and peel off.

FIG. 3(A1) is a side view of powder bed fusion 50 showing a state of a first plume 36a generated above powder bed fusion 50 in a state where the pressure of the ambient gas is less than the atmospheric pressure. FIG. 3(A2) is a plan view of powder bed fusion 50 showing a state of powder bed fusion 50 when first plume 36a shown in FIG. 3(A1) is generated.

As shown in FIG. 3(A1), when powder bed fusion 50 is irradiated with laser beam 35 in a state where the pressure of the ambient gas is less than the atmospheric pressure, first plume 36a in which the metallic vapor is diffused in a wide range is generated above powder bed fusion 50.

In the case of first plume 36a having such a wide diffusion range, a high-speed vapor flow and a high-speed gas flow are generated by the expansion of the vapor. Thus, when powder bed fusion 50 is irradiated with laser beam 35 in a state where the pressure of the ambient gas is less than the atmospheric pressure, powder 9 is scattered. In this case, as shown in FIG. 3(A1), spatter may be generated, or as shown in FIG. 3(A2), a peeled region 72 where powder 9 is peeled from powder bed fusion 50 may be generated in powder bed fusion 50 around a bead 71 constituting molding object 7.

As shown in FIG. 3(B1), when powder bed fusion 50 is irradiated with laser beam 35 in a state where the pressure of the ambient gas is the same as the atmospheric pressure, a second plume 36b is generated above powder bed fusion 50 as a metallic vapor. Second plume 36b expands in a smaller range than first plume 36a of FIG. 3(A1).

In the case of such second plume 36b, an ascending air current 37 is generated around second plume 36b by the expansion of the vapor. Thus, when powder bed fusion 50 is irradiated with laser beam 35 in a state where the pressure of the ambient gas is the same as the atmospheric pressure, powder 9 is sucked by ascending air current 37. In this case, as shown in FIG. 3(B1), powder 9 may be moved, or as shown in FIG. 3(B2), peeled region 72 where powder 9 is peeled from powder bed fusion 50 may be generated in powder bed fusion 50 around bead 71 constituting molding object 7.

As shown in FIG. 3(C1), when powder bed fusion 50 is irradiated with laser beam 35 in a state where the pressure of the ambient gas is higher than the atmospheric pressure, a third plume 36c is generated above powder bed fusion 50 as a metallic vapor. Third plume 36c expands in a smaller range than second plume 36b of FIG. 3(B1).

In the case of such third plume 36c, the expansion of the vapor is suppressed, and thus, when powder bed fusion 50 is irradiated with laser beam 35, the vapor flow, the gas flow, and the ascending air current generated are smaller than those in first plume 36a and second plume 36b described above. Thus, in the case of third plume 36c, which occurs when powder bed fusion 50 is irradiated with laser beam 35 in a state where the pressure of the ambient gas is higher than the atmospheric pressure, the behavior of powder 9 is more stable than those in first plume 36a and second plume 36b described above.

Therefore, in such a case, as shown in FIG. 3(C1), the movement of powder 9 may be suppressed, or as shown in FIG. 3(C2), the spread of the range of peeled region 72 where powder 9 is peeled from powder bed fusion 50 may be suppressed in powder bed fusion 50 around bead 71 constituting molding object 7. In this way, in third plume 36c, by suppressing the expansion of the vapor, the behavior of powder 9 in powder bed fusion 50 is stabilized, and thus, bead 71 having a favorable configuration is formed.

Iron and iron-based materials in powder 9 as the material of the molding object have a higher vapor pressure than that of titanium and the like, and thus, the behavior of the powder is more likely to be unstable due to the influence of the plume. Therefore, in the case of iron and iron-based materials, the effect of controlling the pressure of the ambient gas is remarkable.

As the ambient gas, various gases such as nitrogen gas, helium gas, argon gas, and neon gas can be used. In order to confine the plume diffusion range to a relatively small region, an ambient gas having a higher molecular weight may be adopted.

In additive manufacturing apparatus 1 of the first embodiment, in consideration of the relation among the pressure of the ambient gas, the plume, and the powder scattering as described above, the pressure of the ambient gas is controlled so that the pressure of the ambient gas is higher than the atmospheric pressure when powder bed fusion 50 is irradiated with laser beam 35.

### [Relation Between Pressure of Ambient Gas and Melting Cross-Sectional Area]

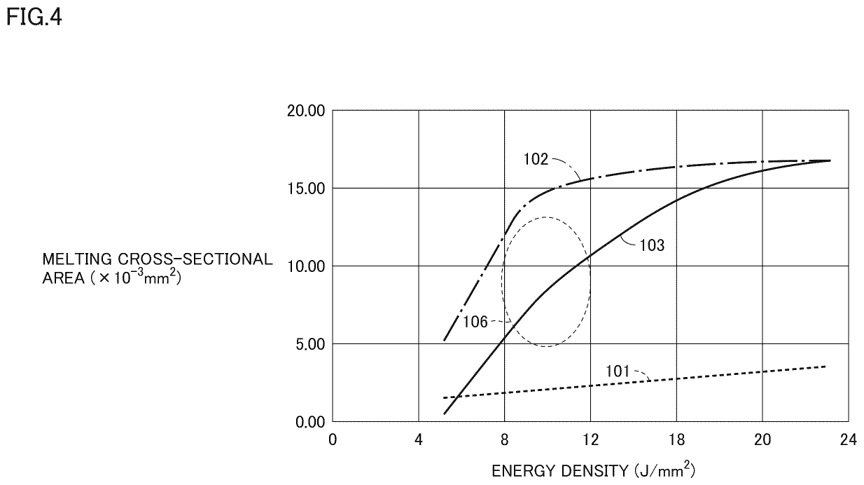

FIG. 4 is a graph showing a relation between the pressure of the ambient gas and a melting cross-sectional area of an iron-based material. In FIG. 4, the horizontal axis represents the energy density of the laser beam, and the vertical axis represents the melting cross-sectional area.

In FIG. 4, the relation between the energy density and the melting cross-sectional area is shown in a comparable manner for the case where the pressure of the ambient gas is less than the atmospheric pressure, the case where the pressure of the ambient gas is the same as the atmospheric pressure, and the case where the pressure of the ambient gas is higher than the atmospheric pressure.

In FIG. 4, a case of a first state 101 where the pressure of the ambient gas is less than the atmospheric pressure (for example, 16 kPa) is indicated by a broken line. In FIG. 4, a case of a second state 102 where the pressure of the ambient gas is the same as the atmospheric pressure (for example, 100 kPa) is indicated by a dot-dashed line. In FIG. 4, a case of a third state 103 where the pressure of the ambient gas is higher than the atmospheric pressure (for example, 120 kPa) is indicated by a solid line.

The melting cross-sectional area is a cross-sectional area of a bead (for example, bead 71 as shown in FIG. 3) of molding object 7 obtained by melting powder 9 in response to the irradiation with laser beam 35 to powder bed fusion 50 for molding one layer of molding object 7.

In FIG. 4, a range 106 in which the behavior of powder 9 in powder bed fusion 50 is stable and a bead having a good configuration is obtained is shown by the relation between the melting cross-sectional area and the energy density. In the case of first state 101, the scattered amount of powder 9 is large, and thus, the remaining amount of powder 9 is not within range 106 in which a favorable bead can be obtained, and a favorable bead cannot be obtained. In the case of second state 102, the melted amount of powder 9 is too large, and thus, the remaining amount of powder 9 is not within range 106 in which a favorable bead can be obtained, and a favorable bead cannot be obtained. In contrast, in the case of third state 103, the scattered amount of powder 9 is smaller and the melted amount of powder 9 is not too large compared to the cases of first state 101 and second state 102, thereby each of the remaining amounts of powder 9 is within range 106 in which a favorable bead can be obtained, and thus, a favorable bead can be obtained.

Based on the relation between the pressure of the ambient gas and the melting cross-sectional area described above, a favorable bead can be obtained as long as the state is controlled to be third state 103 where the pressure of the ambient gas is higher than the atmospheric pressure (for example, 120 kPa). Therefore, in additive manufacturing apparatus 1, when powder bed fusion 50 is irradiated with laser beam 35 to perform molding, controller 82 performs control to increase the pressure of the ambient gas in chamber 2 to be higher than the atmospheric pressure (for example, 120 kPa).

### [Processing of Pressure Control Method of Ambient Gas in Additive Manufacturing Apparatus 1]

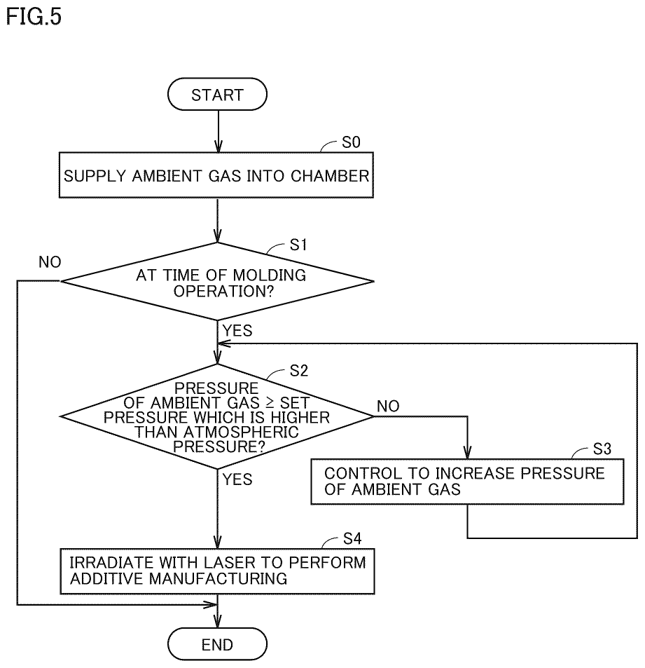

FIG. 5 is a flowchart showing a method of controlling the pressure of the ambient gas of additive manufacturing apparatus 1. The pressure control of the ambient gas shown in FIG. 5 is performed by CPU 82a of controller 82.

Before performing the pressure control of the ambient gas, CPU 82a supplies the ambient gas from gas supply device 88 into chamber 2 through gas supply path 22 in step S0. Thus, the internal space of chamber 2 is filled with the ambient gas.

In step S1, CPU 82a determines whether or not the current time is the time of the molding operation of molding object 7 in additive manufacturing apparatus 1. When CPU 82a determines that the current time is not the time of the molding operation in step S1, CPU 82a ends the processing. On the other hand, when CPU 82a determines that the current time is the time of the molding operation in step S1, CPU 82a determines whether or not the pressure of the ambient gas in chamber 2 is greater than or equal to a set pressure (for example, 120 kPa), which is higher than the atmospheric pressure, in step S2. Specifically, in step S2, CPU 82a checks the pressure of the ambient gas in chamber 2 based on detection signals from pressure detection device 85, and determines whether or not the pressure is greater than or equal to the set pressure which is higher than the atmospheric pressure.

CPU 82a performs control to increase the pressure of the ambient gas in step S3 when the pressure of the ambient gas is not greater than or equal to the set pressure, which is higher than the atmospheric pressure, in step S2. Specifically, in step S2, for example, the ambient gas with a temperature lower than the temperature of the space in chamber 2 is supplied from gas supply device 88 and the ambient gas is expanded by the heat energy in chamber 2 to control to increase the pressure of the ambient gas. According to steps S2 and S3, the pressure of the ambient gas is increased to be greater than or equal to the set pressure which is higher than the atmospheric pressure.

When the pressure of the ambient gas is greater than or equal to the set pressure which is higher than the atmospheric pressure in step S2, CPU 82a performs control to irradiate laser beam 35 in processing stage device 5 to perform additive manufacturing in step S4. Specifically, in step S4, as described above, laser oscillation device 84 oscillates a laser beam, and laser beam 35 thereof is irradiated to powder bed fusion 50 in molding region 54 of processing stage device 5 provided in chamber 2 via galvanometer mirror device 3. Thus, powder bed fusion 50 in molding region 54 is irradiated with laser beam 35 to mold molding object 7.

During the molding operation, steps S1 to S4 are repeatedly performed, and thus, the pressure of the ambient gas in chamber 2 is controlled to be higher than the atmospheric pressure only when powder bed fusion 50 is irradiated with laser beam 35. In the period in which laser beam 35 is not irradiated, the pressure of the ambient gas is not controlled to be higher than the atmospheric pressure, and thus, the pressure of the ambient gas in chamber 2 may be reduced when fumes (vapor of the melted metal which has become individual particles in the ambient gas) are exhausted, etc.

In the pressure control of the ambient gas shown in FIG. 5, the case where the pressure of the ambient gas is set to be greater than or equal to the set pressure which is higher than the atmospheric pressure has been described, and the pressure of the ambient gas only needs to be greater than or equal to the atmospheric pressure. Further, the pressure of the ambient gas in a case where the pressure of the ambient gas is set to be greater than or equal to the atmospheric pressure may have a predetermined upper limit value (for example, 10 atm).

In the first embodiment, by performing the pressure control of the ambient gas as described above, when the additive manufacturing of the molding object is performed by irradiating powder bed fusion 50 with laser beam 35, the pressure of the ambient gas in chamber 2 is made higher than the atmospheric pressure, thereby diffusion of the plume is suppressed and the behavior of powder 9 in powder bed fusion 50 is stabilized, and thus, when molding object 7 is molded, formation of spatter and voids can be suppressed, and occurrence of defects in the molding object can be suppressed.

In the first embodiment, in the pressure control of the ambient gas, the pressure of the ambient gas in chamber 2 is controlled to be higher than the atmospheric pressure only when powder bed fusion 50 is irradiated with laser beam 35, and thus the load of the control process in controller 82 can be reduced.

In the first embodiment, the ambient gas with a temperature lower than the temperature of the space in chamber 2 is supplied from gas supply device 88 into chamber 2, and thus, the ambient gas can be expanded by the thermal energy in chamber 2. Thus, the pressure of the ambient gas in chamber 2 can be controlled to be higher than the atmospheric pressure by the thermal energy in chamber 2.

Powder 9 as the material of the molding object may be a powder of a metal other than iron and an iron-based metal containing iron. In the first embodiment, the ambient gas with a temperature lower than the temperature of the space in chamber 2 is supplied from gas supply device 88 into chamber 2, and thus, the ambient gas can be expanded by the thermal energy in chamber 2. Thus, the pressure of the ambient gas in chamber 2 can be controlled to be higher than the atmospheric pressure by the thermal energy in chamber 2.

### Second Embodiment

The second embodiment illustrates another example of the control for increasing the pressure of the ambient gas in step S4 of the pressure control of the ambient gas shown in FIG. 5.

The second embodiment illustrates the example that when the control for increasing the pressure of the ambient gas is performed in step S4 of the pressure control of the ambient gas shown in FIG. 5, the temperature of the ambient gas in chamber 2 is changed instead of supplying the ambient gas with a temperature lower than the temperature of the space in chamber 2 from the gas supply device, thereby performing control to increase the pressure of the ambient gas.

In the second embodiment, a heater device 89 as indicated by a broken line in chamber 2 of FIG. 1 is provided as a device for changing the temperature of the ambient gas in chamber 2. As indicated by a broken line in FIG. 2, the operation of heater device 89 is controlled by controller 82. For example, in the second embodiment, when the control for increasing the pressure of the ambient gas is performed in step S4 of the pressure control of the ambient gas shown in FIG. 5, CPU 82a operates heater device 89 to perform control to increase the temperature of the ambient gas in chamber 2 by the heat energy of heater device 89. In the second embodiment, the temperature of the ambient gas in chamber 2 can be set to be greater than or equal to the set pressure which is higher than the atmospheric pressure by increasing the temperature of the ambient gas in chamber 2.

In the second embodiment, the pressure of the ambient gas is increased by changing the temperature of the ambient gas in chamber 2 by heater device 89, and thus, the pressure of the ambient gas in chamber 2 is made higher than the atmospheric pressure when powder bed fusion 50 is irradiated with laser beam 35 to mold the molding object. Thereby, in the second embodiment, diffusion of the plume is suppressed, and the behavior of powder 9 in powder bed fusion 50 is stabilized, and thus, when molding object 7 is molded, formation of spatter and voids can be suppressed, and occurrence of defects in the molding object can be suppressed.

In the second embodiment, the pressure of the ambient gas in chamber 2 is controlled to be higher than the atmospheric pressure by changing the temperature of the ambient gas in chamber 2, and thus, the pressure control of the ambient gas in chamber 2 can be facilitated.

### Third Embodiment

The third embodiment illustrates still another example of the control for increasing the pressure of the ambient gas in step S4 of the pressure control of the ambient gas shown in FIG. 5.

The third embodiment illustrates the example that when the control for increasing the pressure of the ambient gas is performed in step S4 of the pressure control of the ambient gas shown in FIG. 5, the volume of chamber 2 is changed instead of supplying the ambient gas with a temperature lower than the temperature of the space in chamber 2 from the gas supply device, thereby performing control to increase the pressure of the ambient gas in chamber 2 to be higher than the atmospheric pressure.

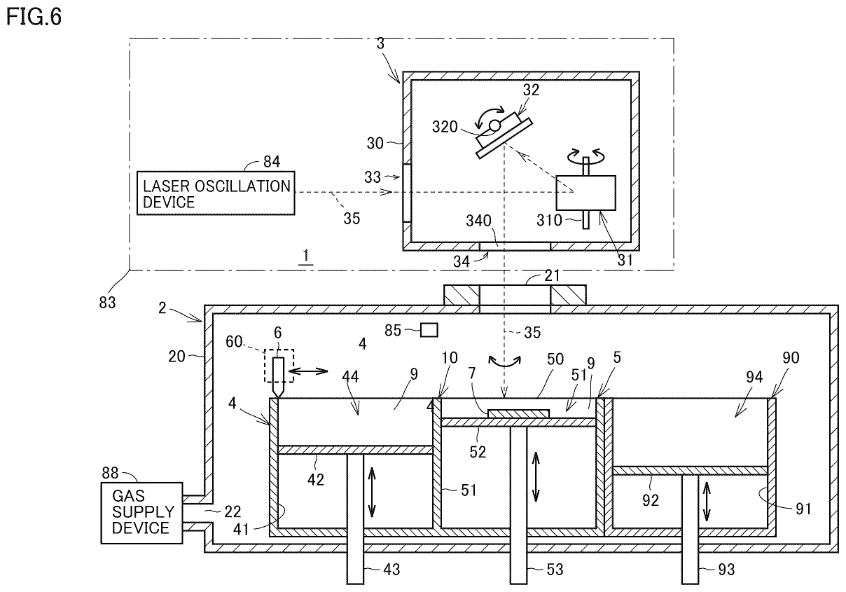

FIG. 6 is a sectional view of additive manufacturing apparatus 1 showing a configuration of a volume adjusting device 90 of additive manufacturing apparatus 1 according to a third embodiment. The configuration of FIG. 6 is different from the configuration of FIG. 1 in that volume adjusting device 90 is provided inside chamber 2.

Volume adjusting device 90 includes a third guide chamber 91, a third stage 92, and a third movable prop 93. Third stage 92 is mounted on third movable prop 93. Third stage 92 and third movable prop 93 are provided inside third guide chamber 91. In the internal space of third guide chamber 91, third movable prop 93 and third stage 92 are provided in a manner that third stage 92 can be elevated and lowered along an inner wall of third guide chamber 91.

Third movable prop 93 can move up and down in the axial direction as indicated by arrows in the drawing. Thus, third stage 92 can be elevated and lowered in accordance with the up-down movement of third movable prop 93. A ring-shaped airtight holding member (not shown) is provided on the outer peripheral portion of third stage 92, and thus the outer peripheral portion of third stage 92 and the inner wall of third guide chamber 91 are airtightly held.

A space 94 defined by the upper surface of third stage 92 and the inner wall of third guide chamber 91 is widened as third stage 92 is lowered. Thus, as third stage 92 is lowered, the volume of the internal space of chamber 2 increases. On the other hand, as third stage 92 is raised, the volume of the internal space of chamber 2 decreases.

Volume adjusting device 90 can change the volume of the internal space of chamber 2 by changing the position of third stage 92. Thus, in the third embodiment, the volume of the internal space of chamber 2 is changed by volume adjusting device 90, thereby the pressure of the ambient gas in chamber 2 can be made higher than the atmospheric pressure.

As indicated by a broken line in FIG. 2, the operation of volume adjusting device 90 is controlled by controller 82. Volume adjusting device 90 shown in FIG. 2 includes a driving device for driving third movable prop 93. In the third embodiment, when the control for increasing the pressure of the ambient gas is performed in step S4 of the pressure control of the ambient gas shown in FIG. 5, CPU 82a operates volume adjusting device 90 to raise third stage 92 to narrow space 94 and reduce the volume of the internal space of chamber 2. Thus, in the third embodiment, control is performed to compress the ambient gas in chamber 2 and increase the pressure of the ambient gas. In the third embodiment, the temperature of the ambient gas in chamber 2 can be set to be greater than or equal to the set pressure which is higher than the atmospheric pressure by decreasing the volume of the inside of chamber 2.

In the third embodiment, the pressure of the ambient gas is increased by changing the volume of the inside of chamber 2 by volume adjusting device 90, and thus, the pressure of the ambient gas in chamber 2 is made higher than the atmospheric pressure when powder bed fusion 50 is irradiated with laser beam 35 to mold the molding object. Thereby, in the third embodiment, diffusion of the plume is suppressed, and the behavior of powder 9 in powder bed fusion 50 is stabilized, and thus, when molding object 7 is molded, formation of spatter and voids can be suppressed, and occurrence of defects in the molding object can be suppressed.

In the third embodiment, the pressure of the ambient gas in chamber 2 is controlled to be higher than the atmospheric pressure by changing the volume of chamber 2, and therefore, the pressure of the ambient gas in chamber 2 can be controlled to be higher than the atmospheric pressure without controlling a device other than chamber 2.

### [Modifications of Embodiments]

(1) The first to third embodiments illustrate the examples in which powder bed fusion 50 is irradiated with laser beam 35 as the energy beam when additive manufacturing apparatus 1 performs additive manufacturing. However, the present invention is not limited to this, and other energy beams such as an electron beam may be used when additive manufacturing apparatus 1 performs additive manufacturing.

(2) The first to third embodiments illustrate the examples in which an inert gas is used as the ambient gas. However, the present invention is not limited to this, and an ambient gas other than an inert gas may be used as the ambient gas. Powder 9 may be made of a material other than metal, such as resin.

(3) The first to third embodiments illustrate the examples in which the pressure of the internal space of chamber 2 of additive manufacturing apparatus 1 is controlled to be higher than the atmospheric pressure only during the period in which the additive manufacturing of molding object 7 is performed by irradiating powder bed fusion 50 with laser beam 35. However, the pressure in the internal space of chamber 2 of additive manufacturing apparatus 1 may be controlled to be higher than the atmospheric pressure even in a period other than the period in which powder bed fusion 50 is irradiated with laser beam 35. For example, the pressure of the internal space of chamber 2 of additive manufacturing apparatus 1 may be controlled to be higher than the atmospheric pressure at all times. Therefore, controller 82 only needs to perform control to increase the pressure of the ambient gas in chamber 2 to be higher than the atmospheric pressure at least during the period when powder bed fusion 50 is irradiated with laser beam 35.

(4) When the pressure of the ambient gas in the internal space of chamber 2 of additive manufacturing apparatus 1 is controlled to be higher than the atmospheric pressure, the ambient gas itself supplied from gas supply device 88 to the inside of chamber 2 may be controlled to be higher than the atmospheric pressure.

(5) In the third embodiment, as the configuration for increasing the pressure of the ambient gas by changing the volume of the inside of chamber 2, other configurations may be adopted, such as a configuration in which a movable airtight wall portion is provided in the internal space of chamber 2, and the movable airtight wall portion is operated to change the volume of the inside of chamber 2, thereby increasing the pressure of the ambient gas.

### [Supplementary Note]

As described above, the present embodiment includes the following disclosure.

### [Configuration 1]

An additive manufacturing apparatus (additive manufacturing apparatus 1) includes:
a chamber (chamber 2);
a gas supply device (gas supply device 88) that supplies an ambient gas into the chamber (chamber 2);
an irradiation device (irradiation device 83) that irradiates a molding region (molding region 54) with an energy beam (laser beam 35) in order to mold a three dimensional molding object (molding object 7), the molding region (molding region 54) being provided with a powder bed fusion (powder bed fusion 50) on which a powder (powder 9) is spread in the chamber (chamber 2); and
a controller (controller 82) that performs control related to additive manufacturing of the molding object (molding object 7), wherein
the controller (controller 82) is configured to increase a pressure of the ambient gas in the chamber (chamber 2) to be higher than an atmospheric pressure when the molding object (molding object 7) is molded.

According to this configuration, when the energy beam (laser beam 35) is irradiated to the molding region (molding object 7) provided with the powder bed fusion (powder bed fusion 50) to mold the molding object (molding object 7), the pressure of the ambient gas in the chamber (chamber 2) is controlled to be higher than the atmospheric pressure, thereby diffusion of the plume is suppressed and the behavior of powder in the powder bed fusion (powder bed fusion 50) is stabilized, and thus, when the molding object (molding object 7) is molded, formation of spatter and voids can be suppressed, and occurrence of defects in the molding object (molding object 7) can be suppressed.

### [Configuration 2]

The additive manufacturing apparatus (additive manufacturing apparatus 1) according to configuration 1, wherein the controller (controller 82) is configured to increase the pressure of the ambient gas in the chamber (chamber 2) to be higher than the atmospheric pressure at least during a period when the powder bed fusion (powder bed fusion 50) is irradiated with the energy beam (laser beam 35).

According to this configuration, the pressure of the ambient gas in the chamber (chamber 2) is controlled to be higher than the atmospheric pressure only when the powder bed fusion (powder bed fusion 50) is irradiated with the laser beam (laser beam 35), and thus, the load of the control process in the controller (controller 82) can be reduced.

### [Configuration 3]

The additive manufacturing apparatus (additive manufacturing apparatus 1) according to configuration 1 or configuration 2, wherein the controller (controller 82) is configured to increase the pressure of the ambient gas in the chamber (chamber 2) to be higher than the atmospheric pressure by performing control so as to supply the ambient gas with a temperature lower than a temperature of a space in the chamber (chamber 2) from the gas supply device (gas supply device 88).

According to this configuration, the ambient gas with a temperature lower than the temperature of the space in the chamber (chamber 2) is supplied from the gas supply device (gas supply device 88) into the chamber (chamber 2), and thus, the ambient gas can be expanded by the thermal energy in the chamber (chamber 2). Thus, the pressure of the ambient gas in the chamber (chamber 2) can be controlled to be higher than the atmospheric pressure by the thermal energy in the chamber (chamber 2).

### [Configuration 4]

The additive manufacturing apparatus (additive manufacturing apparatus 1) according to configuration 1 or configuration 2, wherein the controller (controller 82) is configured to increase the pressure of the ambient gas in the chamber (chamber 2) to be higher than the atmospheric pressure by changing the temperature of the ambient gas in the chamber (chamber 2).

According to this configuration, the pressure of the ambient gas in the chamber (chamber 2) is controlled to be higher than the atmospheric pressure by changing the temperature of the ambient gas in the chamber (chamber 2), and thus, the pressure control of the ambient gas in the chamber (chamber 2) can be facilitated.

### [Configuration 5]

The additive manufacturing apparatus (additive manufacturing apparatus 1) according to configuration 1 or configuration 2, wherein the controller (controller 82) is configured to increase the pressure of the ambient gas in the chamber (chamber 2) to be higher than the atmospheric pressure by changing a volume of the chamber (chamber 2).

According to this configuration, the pressure of the ambient gas in the chamber (chamber 2) is controlled to be higher than the atmospheric pressure by changing the volume of the chamber (chamber 2), and therefore, the pressure of the ambient gas in the chamber (chamber 2) can be controlled to be higher than the atmospheric pressure without controlling a device other than the chamber (chamber 2).

### [Configuration 6]

The additive manufacturing apparatus (additive manufacturing apparatus 1) according to any one of configurations 1 to 5, wherein the powder (powder 9) is made of an iron-based material.

According to this configuration, since the powder (powder 9) is made of an iron-based material, it is possible to suppress the diffusion of the plume in the powder (powder 9) made of the iron-based material having a high vapor pressure.

### [Configuration 7]

An additive manufacturing method includes:
supplying an ambient gas from a gas supply device (gas supply device 88) into a chamber (chamber 2) (step S0);
irradiating a molding region (molding region 54) with an energy beam (laser beam 35) from an irradiation device (irradiation device 83) in order to mold a three dimensional molding object (molding object 7), the molding region (molding region 54) being provided with a powder bed fusion (powder bed fusion 50) on which a powder (powder 9) is spread in the chamber (chamber 2) (step S4); and
increasing a pressure of the ambient gas in the chamber (chamber 2) to be higher than an atmospheric pressure when the molding object (molding object 7) is molded (step S3).

According to this configuration, when the energy beam is irradiated to the molding region provided with the powder bed fusion to mold the molding object, the pressure of the ambient gas in the chamber is controlled to be higher than the atmospheric pressure, thereby diffusion of the plume is suppressed and the behavior of powder in the powder bed fusion is stabilized, and thus, when the molding object is molded, formation of spatter and voids can be suppressed, and occurrence of defects in the molding object can be suppressed.

### [Configuration 8]

The additive manufacturing method according to configuration 7, wherein the increasing the pressure of the ambient gas in the chamber (chamber 2) to be higher than the atmospheric pressure (Step S3) includes increasing the pressure of the ambient gas in the chamber (chamber 2) to be higher than the atmospheric pressure at least during a period when the powder bed fusion (powder bed fusion 50) is irradiated with the energy beam (laser beam 35).

According to this configuration, the pressure of the ambient gas in the chamber (chamber 2) is controlled to be higher than the atmospheric pressure only when the powder bed fusion (powder bed fusion 50) is irradiated with the laser beam (laser beam 35), and thus, the load of the control process in the controller (controller 82) can be reduced.

### [Configuration 9]

The additive manufacturing method according to configuration 7 or configuration 8, wherein the increasing the pressure of the ambient gas in the chamber (chamber 2) to be higher than the atmospheric pressure (Step S3) includes increasing the pressure of the ambient gas in the chamber (chamber 2) to be higher than the atmospheric pressure by supplying the ambient gas with a temperature lower than a temperature of a space in the chamber (chamber 2) from the gas supply device (gas supply device 88).

According to this configuration, the ambient gas with a temperature lower than the temperature of the space in the chamber (chamber 2) is supplied from the gas supply device (gas supply device 88) into the chamber (chamber 2), and thus, the ambient gas can be expanded by the thermal energy in the chamber (chamber 2). Thus, the pressure of the ambient gas in the chamber (chamber 2) can be controlled to be higher than the atmospheric pressure by the thermal energy in the chamber (chamber 2).

### [Configuration 10]

The additive manufacturing method according to configuration 7 or configuration 8, wherein the increasing the pressure of the ambient gas in the chamber (chamber 2) to be higher than the atmospheric pressure (Step S3) includes increasing the pressure of the ambient gas in the chamber (chamber 2) to be higher than the atmospheric pressure by changing the temperature of the ambient gas in the chamber (chamber 2).

According to this configuration, the pressure of the ambient gas in the chamber (chamber 2) is controlled to be higher than the atmospheric pressure by changing the temperature of the ambient gas in the chamber (chamber 2), and thus, the pressure control of the ambient gas in the chamber (chamber 2) can be facilitated.

### [Configuration 11]

The additive manufacturing method according to configuration 7 or configuration 8, wherein the increasing the pressure of the ambient gas in the chamber (chamber 2) to be higher than the atmospheric pressure (Step S3) includes increasing the pressure of the ambient gas in the chamber (chamber 2) to be higher than the atmospheric pressure by changing a volume of the chamber (chamber 2).

According to this configuration, the pressure of the ambient gas in the chamber (chamber 2) is controlled to be higher than the atmospheric pressure by changing the volume of the chamber (chamber 2), and therefore, the pressure of the ambient gas in the chamber (chamber 2) can be controlled to be higher than the atmospheric pressure without controlling a device other than the chamber (chamber 2).

### [Configuration 12]

The additive manufacturing method according to any one of configurations 7 to 11, wherein the powder (powder 9) is made of an iron-based material.

According to this configuration, since the powder (powder 9) is made of an iron-based material, it is possible to suppress the diffusion of the plume in the powder (powder 9) made of the iron-based material having a high vapor pressure.

Although the embodiments of the present invention have been described, it should be understood that the embodiments disclosed herein are illustrative and non-restrictive in every respect. The scope of the present invention is defined by claims, and is intended to include all modifications within the scope and meaning equivalent to the claims.

What is claimed is:

1. An additive manufacturing apparatus comprising:
a chamber;
a gas supply device that supplies an ambient gas into the chamber;
an irradiation device that irradiates a molding region with an energy beam in order to mold a three dimensional molding object, the molding region being provided with a powder bed fusion on which a powder is spread in the chamber; and
a controller that performs control related to additive manufacturing of the molding object, wherein
the controller is configured to increase a pressure of the ambient gas in the chamber to be higher than an atmospheric pressure when the molding object is molded.

2. The additive manufacturing apparatus according to claim 1, wherein the controller is configured to increase the pressure of the ambient gas in the chamber to be higher than the atmospheric pressure at least during a period when the powder bed fusion is irradiated with the energy beam.

3. The additive manufacturing apparatus according to claim 1, wherein the controller is configured to increase the pressure of the ambient gas in the chamber to be higher than the atmospheric pressure by performing control so as to supply the ambient gas with a temperature lower than a temperature of a space in the chamber from the gas supply device.

4. The additive manufacturing apparatus according to claim 1, wherein the controller is configured to increase the pressure of the ambient gas in the chamber to be higher than the atmospheric pressure by changing the temperature of the ambient gas in the chamber.

5. The additive manufacturing apparatus according to claim 1, wherein the controller is configured to increase the pressure of the ambient gas in the chamber to be higher than the atmospheric pressure by changing a volume of the chamber.

6. The additive manufacturing apparatus according to claim 1, wherein the powder is made of an iron-based material.

7. An additive manufacturing method comprising:
supplying an ambient gas from a gas supply device into a chamber;
irradiating a molding region with an energy beam from an irradiation device in order to mold a three dimensional molding object, the molding region being provided with a powder bed fusion on which a powder is spread in the chamber; and
increasing a pressure of the ambient gas in the chamber to be higher than an atmospheric pressure when the molding object is molded.

8. The additive manufacturing method according to claim 7, wherein the increasing the pressure of the ambient gas in the chamber to be higher than the atmospheric pressure includes increasing the pressure of the ambient gas in the chamber to be higher than the atmospheric pressure at least during a period when the powder bed fusion is irradiated with the energy beam.

9. The additive manufacturing method according to claim 7, wherein the increasing the pressure of the ambient gas in the chamber to be higher than the atmospheric pressure includes increasing the pressure of the ambient gas in the chamber to be higher than the atmospheric pressure by supplying the ambient gas with a temperature lower than a temperature of a space in the chamber from the gas supply device.

10. The additive manufacturing method according to claim 7, wherein the increasing the pressure of the ambient gas in the chamber to be higher than the atmospheric pressure includes increasing the pressure of the ambient gas in the chamber to be higher than the atmospheric pressure by changing the temperature of the ambient gas in the chamber.

11. The additive manufacturing method according to claim 7, wherein the increasing the pressure of the ambient gas in the chamber to be higher than the atmospheric pressure includes increasing the pressure of the ambient gas in the chamber to be higher than the atmospheric pressure by changing a volume of the chamber.

12. The additive manufacturing method according to claim 7, wherein the powder is made of an iron-based material.
